(19) United States
(12) Patent Application Publication
(10) Pub. No.: US 2010/0049662 A1
(43) Pub. Date: Feb. 25, 2010

(54) SYSTEM AND METHOD FOR FACILITATING EMPLOYMENT SEARCHES

(76) Inventors: Richard J. Price, Menomonie, WI (US); Richard J. Best, Menomonie, WI (US); Matthew M. Pronschinske, Eau Claire, WI (US)

Correspondence Address: WHYTE HIRSCHBOECK DUDEK S.C.;INTELLECTUAL PROPERTY DEPARTMENT, 33 East Main Street, Suite 300, Madison, WI, 53703-4655, US

(21) Appl. No.: 12/537,400

(22) Filed: Aug. 7, 2009

Related U.S. Application Data
(60) Provisional application No. 61/087,071, filed on Aug. 7, 2008.

(51) Int. Cl. G06Q 10/00; G06F 17/30; G06F 7/00

(52) U.S. Cl. 705/321; 707/791; 707/769; 707/E17.018; 707/E17.108

(57) ABSTRACT

A system and method is provided for facilitating and assisting employment related searches. Prospective employees and prospective employers can access and upload employment related information, which can pertain to available positions and positions being sought. Prospective employees remain anonymous until they decided to provide identifying information. Prospective employers can search prospective employees and communicate directly with them under complete anonymity.

### CROSS REFERENCE TO RELATED APPLICATIONS

The present application claims priority to U.S. Provisional Application Ser. No. 61/087,071, filed Aug. 7, 2008, titled System and Method for Facilitating Employment Searches, which is hereby incorporated by reference in its entirety herein.

### FIELD OF THE INVENTION

The present invention relates to web based systems for assisting employers and potential employees for the purpose of facilitating employment searches.

### BACKGROUND OF THE INVENTION

The need for anonymous employment searching is of great importance as today's society becomes more transient and willing to move employment positions and careers numerous times throughout a individual's working lifetime. Concealing identities during the employment search process is critical in certain situations. By example, release of the hiring company, position involved and the potential employee could have damaging effects to the company or the potential employee. If a potential employee's identity is made known, their current employer may see that they are seeking to find an alternative position, which could have repercussions for their current state of employment. On the other hand, the hiring company might be concerned about how potential competitors would use the knowledge that the company is searching for employees to upset customers who are relying on the stability of the company. Mere speculation that a company is searching for a new president could dramatically reduce the price of the company's stock.

Therefore, for the above reasons, it would be advantageous to provide an employment search system that protects the identity of the employer, the potential employee, or both, depending upon the circumstances of the employment situation.

### SUMMARY OF THE INVENTION

In accordance with at least one embodiment, the present invention includes a system for facilitating an employment search having a central processing unit (CPU), a memory storage unit for storing computer executable instructions capable of identifying and anonymously communicating with potential employees, a relational database comprising employment related data and a web-based user interface for accessing the relational database and performing employment related search queries.

According to another embodiment, the present invention includes a method for electronically facilitating an employment search comprising a plurality of steps. The steps include performing an employment related search query based at least in part upon employment criteria of potential employees, accessing prospective employee profile information based at least in part upon the search query, and selecting prospective employees based at least in part upon pre-selected employment related criteria. Additionally, the prospective employee contact information is anonymous. Transmitting an electronic message to the anonymous prospective employee is also included.

In accordance with at least one embodiment, the present invention includes a process for electronically performing an employment search comprising a plurality of steps. The process includes performing an employment related search query based at least in part upon potential employer related information, accessing prospective employer profile information based at least in part upon the search query, selecting prospective employers based at least in part upon pre-selected employment related criteria. Additionally, the prospective employee contact information is anonymous. The process also includes transmitting an anonymous electronic message to the prospective employer.

### BRIEF DESCRIPTION OF THE DRAWINGS

FIG. 1 is block diagram of a system in accordance with at least one embodiment of the invention; and

FIG. 2 is a flow chart of an exemplary process for facilitating an employment related search in accordance with at least one embodiment of the present invention.

### DETAILED DESCRIPTION OF THE PREFERRED EMBODIMENT

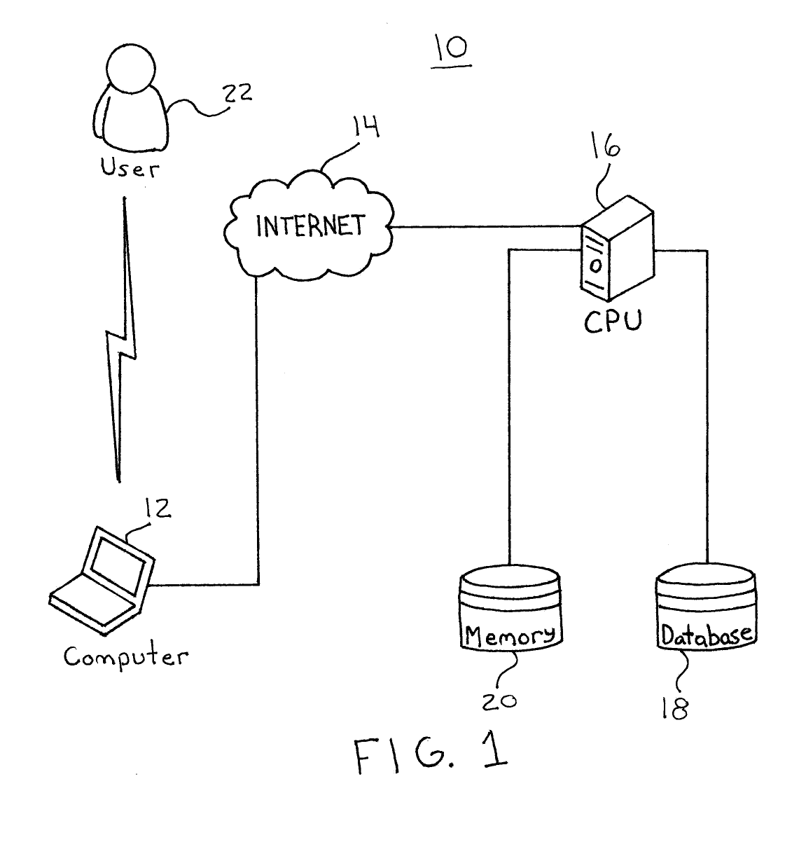

Referring to FIG. 1, a system 10 is provided that facilitates employment searches with user-controlled anonymous communications. The system 10 includes a computer 12, the Internet 14, a central processing unit (CPU) 16, a relational database 18, and a memory storage device 20. Users 22, which include system administrators, employers and employees, access the computer 12. A connection to the Internet 14 is preferred, but is not a necessary component of all embodiments of the system 10. The CPU 16 runs executable instructions, or computer programs, that when executed, facilitate the employment/employee searching process. The system 10 provides a means for potential employers to look through a database 18 associated with users who are potential future employees. The database 18 also stores information relating to the employer-users. The terms job seeker, employee, employee-user, prospective employee and potential employee used herein are synonymous and refer to individuals seeking alternative or new employment. Employers, prospective employers and employer-users are synonymous and refer to those who are in search of filling an employment position.

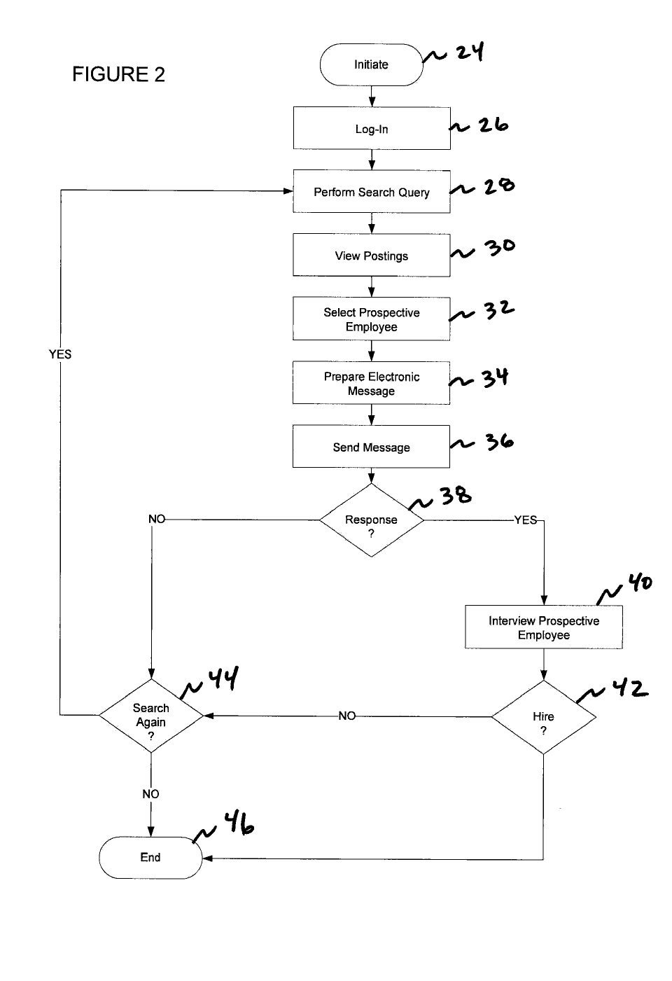

Now referring to FIG. 2, a process for facilitating an employment related search is provided. The process can be written in computer executable code, or instructions, and stored on a computer memory 20, such that a CPU 16 can initiate the process at step 24. Alternatively, it is contemplated that the process can be performed absent a CPU and through an alternative computer processing system. At step 26 a user can log-in to the system 10 and perform a search query at step 28. The search query includes the selection of numerous variables. The query can be performed based at least in part upon a group of variables comprising keyword searching, occupational area, experience level, physical location, employment type, age, educational level, educational type, and various others.

Based upon the search query performed, a list of potential employees is provided to the prospective employer at step 30. The list can be ordered in a variety of ways, including different search query variables. By example, the search results can be ordered by relevance to the optimal level of experience, therefore the results are provided based upon the potential employees experience level. Web page screen shots are provided for listing the available employee-users 22 that meet the search requirements. The format and organization of the potential employee employment related data includes a field for email selection, a snapshot view, the date on which the employee-user data was updated, the location of the employee-user, a summary of the experience and a summary of skills. The potential employee's identity remains confidential and is not disclosed to the employer-users.

Prospective employers can select one or a plurality of prospective employees at step 32. In the event that the prospective employer does not already have a prepared message, an electronic message to the prospective employees is prepared at step 34. Prospective employers can preview, modify and save electronic messages that are prepared. The preview option provides the prospective employer a webpage pop-up which is in the same format as the message to be sent to the prospective employee. After selecting the message and the prospective employees, the prospective employer transmits the message or plurality of messages to the prospective employee at step 36. After receiving an electronic message, the anonymous prospective employee can respond to the message at step 38. If a response is transmitted and received, then an interview between the anonymous prospective employee and prospective employer occurs at step 40. A decision whether to hire the prospective employee is performed at step 42. If the prospective employee is not hired then a decision whether to perform another search is performed at step 44. If a response was not received at step 38, then step 44 is performed. If the prospective employee is hired at step 42, then the method is terminated at step 46. Additionally, if an additional search is declined at step 44, then the process is terminated at step 46.

Electronic mail entry screens are provided for employer-users to be able to contact employee-users for purposes of potential employment. Additionally, schedule and availability times are provided for each prospective employee. The employer-user sign in page allows quick electronic payment, such as through Paypal.

The prospective employee enters a profile web page, which allows the potential employee to enter a new profile or alternatively update an existing profile. After entering a profile, the job seeker can view a snapshot of their profile. The snapshot is a web page “pop-up” which provides pertinent information relating to the potential employees profile information. If the potential employee would like to modify their profile, such that the snapshot will be changed, then a change profile function is provided. In at least one embodiment, the potential employee clicks on a web-link button, which provides the change/update profile screen. The potential employee can provide information through a plurality of data entry fields, such exemplary fields can include career areas of interest, levels of experience, the level of education completed, specific education and training, job titles to be considered, and employment skills.

In an alternative embodiment, the prospective employee changes their existing profile by accesses the system through a web portal and requests to make a change to their profile. After being prompted to enter their email address the prospective employee submits their email address and request. In response to the request an electronic communication is sent to the prospective employee granting them access to change or modify their existing profile. This alternative embodiment represents a method for securely accessing and modifying a prospective employee profile.

Employer-users are able to sign-up for the employment based search services, which allow them to receive lists of potential employees, view snapshots and electronically communicate with the potential employees. Additionally, the employer-users can access email history, profile update links, renew subscription, password change, email template update, and email employee-user links can be available. Prior to sending electronic communications, or emails, through the system 10 the employer-user can view a preview of the message and decide to save, modify or send the message. Employer-user information is secure, where a login ID and password are provided. Employer-user email history, including the date sent, name of sender, and subject can be displayed when requested.

A plurality of features are available, exemplary features include resume development and resume snapshot viewing; business based worker survey capacity; prospective employee schedule and availability functionality; no cost Preview/demo feature function for Employers; customized business/industry search for both prospective employees and employers; GPS mapping of prospective employee locations; and a log of Employer electronic message history. An additional list of exemplary features include prospective employee profile data entry; prospective employee profile update capacity; prospective employee confidentiality and anonymity; prospective employee search of confidential employment functionality; employer online screening or sorting of employee profiles; and employer email to confidential prospective functionality. The system includes computer executable instructions that are capable of identifying selective groups of prospective employees and communicating directly with the group based upon employment related information focused upon the demographics of that group. By example, employees laid-off from a particular business can be targeted for employment related information pertinent to their specific skills and background. The system default is for complete anonymity of the prospective employees while the prospective employers are performing search queries, which prevents access to the prospective employee's resume. Alternatively, the prospective employee has control to grant, modify or deny access to any prospective employer and choose when, or even if, the prospective employer has access to any identifying information.

At least one embodiment of the present system 10 allows a user to upload their respective resume and employment search criteria. The employee-user data is then accessible through search queries generated by potential employers, without the employer being able to view the name or other specific identification data of the employee-user. The employer-user is able to send an email to the employee user through the system without knowing their identity. The employee-user can view the email and decide whether to respond through the system, respond outside of the system, or not respond at all. If the employee-user responds, their name and other identifying information can either be provided or remain anonymous until later communication. The employee-user has the control whether to disclose their information.

According to at least one embodiment, the present invention includes a system for facilitating an employment search having a central processing unit (CPU), a memory storage unit for storing computer executable instructions capable of identifying and anonymously communicating with potential employees, a relational database comprising employment related data and a web-based user interface for accessing the relational database and performing employment related search queries.

According to another embodiment, the present invention includes a method for electronically facilitating an employment search comprising a plurality of steps. The steps include performing an employment related search query based at least in part upon employment criteria of potential employees, accessing prospective employee profile information based at least in part upon the search query, and selecting prospective employees based at least in part upon pre-selected employment related criteria. Additionally, the prospective employee contact information is anonymous. Transmitting an electronic message to the anonymous prospective employee is also included.

In yet another alternative embodiment, the present invention includes a process for electronically performing an employment search comprising a plurality of steps. The process includes performing an employment related search query based at least in part upon potential employer related information, accessing prospective employer profile information based at least in part upon the search query, selecting prospective employers based at least in part upon pre-selected employment related criteria. Additionally, the prospective employee contact information is anonymous. The process also includes transmitting an anonymous electronic message to the prospective employer.

The following documents are hereby incorporated by reference in their entirety herein: U.S. Pat. No. 5,884,270; U.S. Patent Publication US 2008/0016054; and U.S. Patent Publication US 2006/0229902.

It is specifically intended that the present invention not be limited to the embodiments and illustrations contained herein, but include modified forms of those embodiments including portions of the embodiments and combinations of elements of different embodiments as come within the scope of the following claims.

We claim:

1. A system for facilitating an employment search comprising:
a central processing unit (CPU);
a memory storage unit for storing computer executable instructions capable of identifying and anonymously communicating with potential employees;
a relational database comprising employment related data; and
a web-based user interface for accessing the relational database and performing employment related search queries.

2. The system according to claim 1, wherein the relational database includes prospective employee and prospective employer related information.

3. The system according to claim 1, wherein the web-based user interface provides a snapshot view of prospective employees based at least in part upon a prospective employer performed employment related search query.

4. The system according to claim 1, wherein the computer executable instructions are capable of identifying and anonymously communicating with potential employers.

5. The system according to claim 2, wherein the relational database includes geographically mapped prospective employee and prospective employer locations.

6. The system according to claim 4, wherein a prospective employee accesses the web-based interface and performs a search query seeking prospective employment related information.

7. A method for electronically facilitating an employment search comprising the following steps:
performing an employment related search query based at least in part upon employment criteria of potential employees;
accessing prospective employee profile information based at least in part upon the search query;
selecting prospective employees based at least in part upon pre-selected employment related criteria, wherein the prospective employee contact information is anonymous; and
transmitting an electronic message to the anonymous prospective employee.

8. The method according to claim 7, wherein a prospective employee receives the electronic message.

9. The method according to claim 7, further comprising the step of displaying a geographic map charting the location of prospective employees.

10. The method according to claim 7, further comprising the step of requesting prospective employees prepare a response to an electronically submitted employment based survey.

11. The method according to claim 7, wherein a prospective employee is hired based at least in part upon the employment related search query.

12. The method according to claim 8, wherein the prospective employee reviews a prospective employment opportunity.

13. The method according to claim 12, wherein the prospective employee anonymously responds to the transmitted electronic message.

14. The method according to claim 12, wherein the prospective employee requests an interview with the prospective employer.

15. A process for electronically performing an employment search comprising the following steps:
performing an employment related search query based at least in part upon potential employer related information;
accessing prospective employer profile information based at least in part upon the search query;
selecting prospective employers based at least in part upon pre-selected employment related criteria, wherein the prospective employee contact information is anonymous; and
transmitting an anonymous electronic message to the prospective employer.

16. The method according to claim 15, wherein a prospective employer receives the electronic message.

17. The method according to claim 15, further comprising the step of displaying a geographic map charting the location of prospective employees.

18. The method according to claim 15, further comprising the step of requesting prospective employees prepare a response to an electronically submitted employment based survey.

19. The method according to claim 7, wherein a prospective employee is hired based at least in part upon the employment related search query.

20. The method according to claim 16, wherein the prospective employee requests an interview with the prospective employer.
